(19) United States
(12) Patent Application Publication
(10) Pub. No.: US 2007/0299863 A1
(43) Pub. Date: Dec. 27, 2007

(54) PORTABLE OBJECT SERIALIZATION

(75) Inventors: Qiang Fu, Lexington, MA (US); Anuradha Sudhir Krishnan, Acton, MA (US); Ravi Kumar, Shrewsbury, MA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/738,959

(22) Filed: Apr. 23, 2007

Related U.S. Application Data
(60) Provisional application No. 60/795,842, filed on Apr. 27, 2006.

(51) Int. Cl. G06F 17/30

(52) U.S. Cl. 707/102; 707/E17.008

(57) ABSTRACT

Disclosed herein are platform- and device-independent systems and methods for serializing and deserializing data. A method of serializing data stored in a data structure comprises generating a data structure descriptor representing information about a memory layout of the data structure and serializing the stored data based upon the data structure descriptor. The data structure descriptor may include a layout array, including a memory offset and a size corresponding to each member of the data structure. A method of processing serially received data for storage in a data structure comprises receiving a serial data stream, allocating memory for storing the data based upon a data structure descriptor, and deserializing the data stream based upon the data structure descriptor. The data structure descriptor may include a layout array, including a memory offset and a size corresponding to each member of the data structure.

### CLAIM OF PRIORITY UNDER 35 U.S.C. §119

The present Application for patent claims priority to Provisional Application No. 60/795,842 entitled “Portable Object Serialization Method for Embedded System,” filed Apr. 27, 2006, assigned to the assignee hereof and hereby expressly incorporated by reference herein.

### BACKGROUND

I. Field

This invention relates to systems and methods for transferring binary data serially between a host processor and a device, and in particular to systems and methods for serializing and deserializing a data stream in a platform-independent manner.

II. Background

The use of a host processor running a device driver to control and communicate with a remote device is widely practiced in a variety of applications. Typically, binary data streams are frequently exchanged between the host processor and the device. Often binary data are organized at the device driver end, the device end, or both, in a data structure such as the struct data type implemented in the programming language C. When the device driver passes data from a data structure in the host to the device, the device driver first serializes the data (i.e., reads the data sequentially out of host memory) and then transmits the serial stream as a series of bits to the device. The device receives the serialized data and then deserializes the data, i.e. organizes it in bytes, words, or other blocks. Finally the device stores the data in a data structure allocated in device memory. A similar serialize-transmit-deserialize procedure occurs for data passed in the other direction, from the device to the device driver.

To carry out the serialize-transmit-deserialize procedure, a data structure is allocated at the receiving end corresponding to the data structure allocated at the sending end. Implemented at the receiving end is code to deserialize the received data and correctly populate that data structure. For example, when a device driver sends data to a device, the driver's serializing routine converts the data in the structure to serial form, adopting some convention regarding the order in which the elements of the data structure are added to the serial stream, whether bytes or other-sized chunks of data are transmitted in big-endian or little-endian format, and so on. Doing so requires a priori knowledge of the layout in memory of the data structure and the layout in the serial stream of the serialized data structure; when the device receives the stream, the device's deserializing routine must correctly account for the organization and arrangement of the data in the serial stream and in the device memory in order to deserialize the stream correctly. The device's deserializing routine may also need to correctly account for other parameters of the data storage at the driver end, such as whether various data types are stored as bytes, words, or double-words. Finally the device's deserializing routine must also know which data structure is appropriate to allocate memory appropriately to store the received data, as well as the devices local data organization scheme (the length of data types, etc.).

Thus, in such systems, it is necessary to program serialization and deserialization routines to correctly account for the particular parameters of the data structures implemented in the host processor at the host end or the device processor at the device end. Where the number of data structures supported by the device driver and/or the device is large, maintaining copies of all of the supported data structures, along with instructions for serializing and deserializing data from and into each of the supported data structures, expends an impracticable amount of system resources at both the device end and the driver end. For example, in such systems, any change in the device or the device driver requires rewriting and/or recompiling the serialization and deserialization routines to ensure that they correctly account for the organization of the data structures, endian-ness and type lengths, and other parameters. This approach is error-prone, unscalable, and, should the underlying processor change, not portable.

### SUMMARY

Disclosed herein are platform- and device-independent systems and methods for serializing and deserializing data. In one embodiment, a method of serializing for transmission data stored in a data structure is presented that comprises generating a data structure descriptor representing information about a memory layout of the data structure, and serializing the data stored in the data structure based upon the data structure descriptor. In a further embodiment of the method, the data structure includes at least one member, and generating a data structure descriptor includes generating a layout array corresponding to each of the at least one members of the data structure. In still another embodiment of the method, the layout array corresponding to each member of the data structure includes a memory offset and a size of the member of the data structure.

In a further embodiment, a method of processing serially received data for storage in a data structure is presented that comprises receiving a serial data stream, allocating memory for storing the data based upon a data structure descriptor, and deserializing the data stream based upon the data structure descriptor. In a further embodiment of the method, the data structure includes at least one member, and the data structure descriptor includes a layout array corresponding to each member of the data structure. In still a further embodiment of a method, the layout array corresponding to each member of the data structure includes a memory offset and a size of the member of the data structure.

In a further embodiment, a system for serializing for transmission data stored in a data structure is presented, the system comprising a processor that is configured to generate a data structure descriptor representing information about a memory layout of the data structure, and serialize the data stored in the data structure based upon the data structure descriptor. In still a further embodiment, the data structure includes at least one member, and the data structure descriptor includes a layout array corresponding to each member of the data structure. In still another embodiment, the layout array corresponding to each member of the data structure includes a memory offset and a size of the member of the data structure.

In a further embodiment, a system for processing serially received data for storage in a data structure is presented, the system comprising a processor configured to receive a serial data stream, allocate memory for the data structure based upon a data structure descriptor, and deserialize the data stream based upon the data structure descriptor. In still another embodiment the data structure includes at least one member, and the data structure descriptor includes a layout array corresponding to each member of the data structure. In still another embodiment, the layout array corresponding to each member of the data structure includes a memory offset and a size of the member of the data structure.

In a further embodiment, a machine-readable medium carrying instructions for carrying out a method of serializing for transmission data stored in a data structure is described in which the method comprises generating a data structure descriptor, the data structure descriptor representing information about a memory layout of the data structure, and serializing the data stored in the data structure based upon the data structure descriptor. In a further embodiment, the data structure includes at least one member, and the act of generating a data structure descriptor includes generating a layout array corresponding to each of the at least one members of the data structure. In still another embodiment, the layout array corresponding to each member of the data structure includes a memory offset and a size of the member of the data structure.

In a further embodiment, a machine-readable medium carrying instructions for carrying out a method of processing serially received data for storage in a data structure is described, the method comprising receiving a serial data stream, allocating memory for storing the data based upon a data structure descriptor, and deserializing the data stream based upon the data structure descriptor. In still another embodiment the data structure includes at least one member, and the data structure descriptor includes a layout array corresponding to each member of the data structure. In still another embodiment, the layout array corresponding to each member of the data structure includes a memory offset and a size of the member of the data structure.

### BRIEF DESCRIPTION OF THE DRAWINGS

Exemplary embodiments of systems and methods according to the present invention will be understood with reference to the accompanying drawings, which are not intended to be drawn to scale. In the drawings, each identical or nearly identical component that is illustrated in various figures is represented by a like designator. For purposes of clarity, not every component may be labeled in every drawing. In the drawings:

The features and nature of the present invention will become more apparent from the detailed description set forth below when taken in conjunction with the drawings in which like reference characters identify correspondingly throughout.

FIG. 1 is a schematic representation of a computer system on which the systems and methods described herein can be implemented.

FIG. 2 is a flow chart illustrating a process for generating a data structure descriptor and serializing a data structure for transmission.

FIG. 3 is a flow chart illustrating a process for receiving and deserializing a data structure using a data structure descriptor.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items. The word “exemplary” is used herein to mean “serving as an example, instance, or illustration.” Any embodiment or design described herein as “exemplary” is not necessarily to be construed as preferred or advantageous over other embodiments or designs.

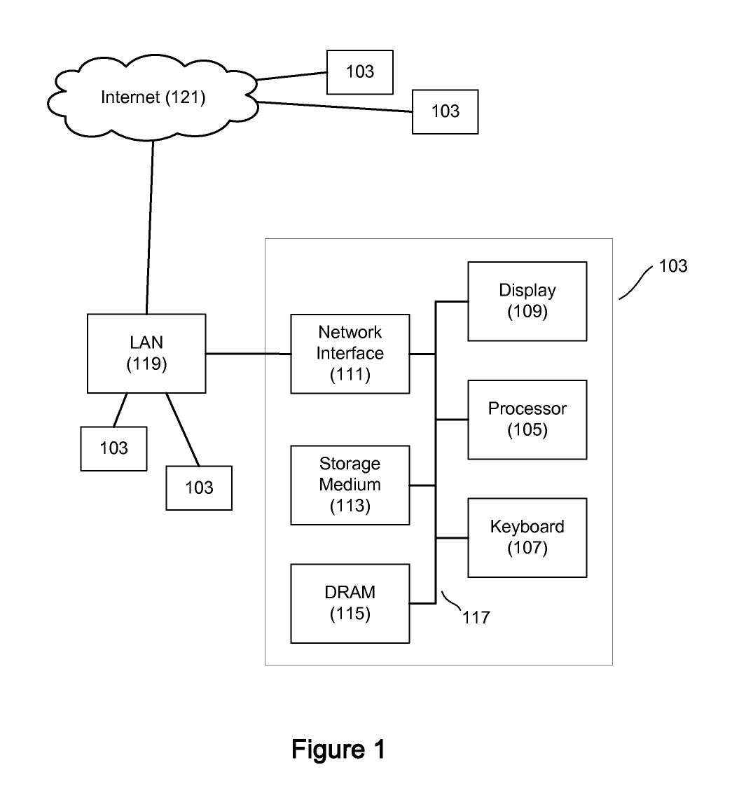

It should be appreciated that the various processes described herein may be implemented on appropriately programmed computer systems, e.g., general purpose computers and/or computing devices 103, such as those illustrated in FIG. 1. A computing device 103 may include a specialized or general purpose computing device such as a cellular phone, a personal digital assistant, and/or any other portable or non-portable computing system that is not a general purpose computer.

Computing device 103 includes a processor 105. A “processor” 105 means one or more microprocessors, central processing units (CPUs), computing devices, microcontrollers, digital signal processors, application specific integrated circuits, or like devices or any combination thereof. A processor may include an Intel® Pentium®, Centrino®, and/or Core® processor. Typically, a processor 105 will receive instructions (e.g., from a memory or like device) and execute those instructions, thereby performing one or more processes defined by those instructions.

Thus, a description of a process is likewise a description of an apparatus for performing the process. The apparatus that performs the process may include, e.g., a processor 105 and those input devices and/or output devices (e.g., a keyboard 107, mouse, trackball, microphone, touch screen, printing device, display screen 109, speaker, network interface 111) that are appropriate to perform the process.

Further, computer programs (i.e., collections of instructions) that implement such methods (as well as other types of data) may be stored and transmitted using a variety of media (e.g., machine-readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

In some embodiments, processor 105 may execute an operating system which may include, for example, the Windows-based operating systems (e.g., Windows NT, Windows 2000 (Windows ME), Windows XP, Windows Vista) available from the Microsoft Corporation, MAC OS System X operating system available from Apple Computer, one or more of the Linux-based operating system distributions (e.g., the Enterprise Linux operating system available from Red Hat, Inc.), the Solaris operating system available from Sun Microsystems, or UNIX operating systems available from various sources. Many other operating systems may be used, and the invention is not limited to any particular operating system.

The processor and operating system together may define a computer platform for which programs stored on a machine-readable medium may be written in various programming languages, including an object-oriented programming language, such as SmallTalk, Java, C++, Ada, Python, or C# (C-Sharp), functional programming languages, scripting programming languages such as JavaScript, and/or logical programming languages. Various aspects of the invention may be implemented in a non-programmed environment (e.g., documents created in HTML, XML or other format that, when viewed in a window of a browser program, render aspects of a GUI or perform other functions). Some implementations of the present invention may be implemented using a plurality of programming languages and techniques known collectively as AJAX to provide a user with an interactive web-based user interface.

Various embodiments of the present invention may include a network environment including one or more computing systems (e.g., general purpose computers and/or other computing devices 103) in communication through one or more communication networks (e.g., a LAN 119, the Internet 121). The computer systems may communicate directly or indirectly, via any wired or wireless medium (e.g., the Internet 121, LAN 119, WAN or Ethernet, Token Ring, a telephone line, a cable line, a radio channel, an optical communications line, commercial on-line service providers, bulletin board systems, a satellite communications link, cellular telephone networks, a WI-FI network, a Bluetooth communication link, a combination of any of the above).

Various aspects of the invention (e.g., program elements stored on machine-readable media and executable by one or more processors) may be distributed among one or more computer systems configured to provide a service to one or more client computer systems. For example, in some embodiments, a plurality of computing systems may be organized as a central authority connected to a LAN or other communication network. These computing systems may receive requests and other information from remote computing systems through the Internet 121.

In some embodiments, a server computer/centralized authority may not be necessary or desirable. For example, the present invention may, in an embodiment, be practiced on one or more computing devices without a central authority. In such an embodiment, any functions described herein as performed by a server or data described as stored on a general purpose computer may instead be performed by or stored on one or more such computing devices.

The term “machine-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks 113 and other persistent memory. Volatile media include dynamic random access memory 115 (DRAM), which typically constitutes the main memory of a computer system. Transmission media include coaxial cables, copper wire and fiber optics, including the wires that comprise a system bus 117 coupled to the processor. Transmission media may include or convey acoustic waves, light waves and electromagnetic emissions, such as those generated during radio frequency (RF) and infrared (IR) data communications. Common forms of machine-readable media include, for example, a floppy disk, a flexible disk, a hard disk, a magnetic tape, any other magnetic medium, a CD-ROM, a DVD, any other optical medium, punch cards, a paper tape, any other physical medium with patterns of holes, a RAM, a PROM, an EPROM, a FLASH-EEPROM, any other memory chip or cartridge, a carrier wave, or any other medium from which a computer can read.

Various forms of machine-readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a machine-readable medium storing a program for performing the process. The machine-readable medium can store (in any appropriate format) those program elements that are appropriate to perform the process.

Where a process is described, in some embodiments the process may operate without any user intervention. In other embodiments, the process includes some human intervention (e.g., an act is performed by or with the assistance of a human).

Just as the description of various acts in a process does not indicate that all the described acts are required, embodiments of an apparatus may include one or more computer systems operable to perform some (but not necessarily all) of the described process.

Likewise, just as the description of various acts in a process does not indicate that all the described acts are required, embodiments of a machine-readable medium storing a program or data structure include a machine-readable medium storing a program that, when executed, can cause one or more processors to perform some (but not necessarily all) of the described process.

For purposes of illustration, an embodiment will be described in which the host processor's device driver serializes the data in a data structure and sends it to a device, which deserializes and stores the data. It should be understood, however, that the exemplary method can readily be extended to data sent by a device to a device driver. In addition, in the illustrative embodiment it is assumed that the serialization and deserialization code is implemented in C, but persons skilled in the art will readily appreciate that the method can be implemented in other languages that employ data structures as well.

Serializing and Deserializing a Data Stream.

In the systems and methods described herein, the serialization and deserialization routines can take into account the memory layout in any given platform of any data structure being serialized or deserialized. Thus they can automatically handle any offsets or conversions that may need to be made during the serialization and/or deserialization processes, without the necessity to rewrite the routines each time a new data structure is implemented or each time the code is ported to a new platform. For example, where the data structure is implemented in C, a data structure descriptor of the memory layout can be generated as needed (for example, at compile time) using C's sizeof ( ) and offset ( ) functions. The data structure descriptor can then be used by the serialization and/or deserialization routines to select a serialization and/or deserialization procedure that correctly accounts for all the parameters of the data structure. In this way, a simple serialization and deserialization code can be used on both the transmitting and receiving side, without the need to account for parameters that are specific to processor architecture or compiler. Moreover, the serialization and deserialization code is the same for any data structures, eliminating the need to store copies of every supported data structure and separate serialization and deserialization code to read from and/or populate each data structure.

When a device driver needs to send the contents of a data structure to a device, in an exemplary embodiment of the present invention the device driver determines the layout information for the data structure, in order to generate a data structure descriptor that will be used by the serialization routine to process the stored data for serial transmission.

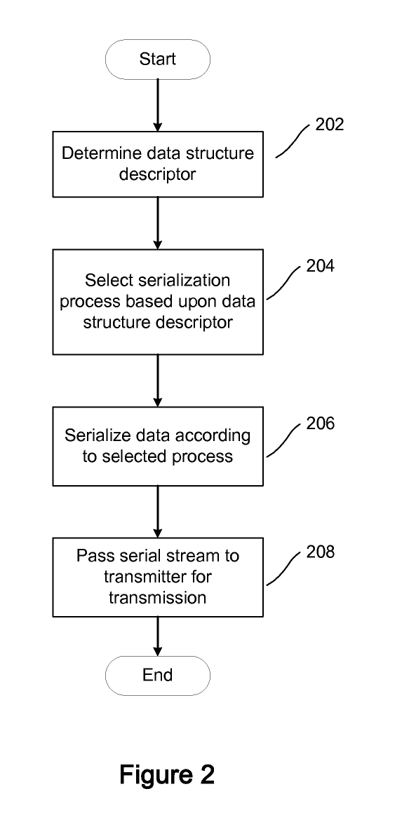

The layout information associated with a data structure typically includes the size (number of bytes) and offset (number of bytes) of each element of the data structure. It may also include flags or similar descriptors indicating word order, whether the elements are stored in big-endian or little-endian format, or other parameters. Thus the memory layout of the data structure can be described by a data structure descriptor, which may be an array of {offset, size} pairs, {offset, size, byte-order} triplets, or similar descriptors. Referring to FIG. 2, the step of determining the data structure descriptor is represented by element 202 of the flow chart. In some embodiments, the data structure descriptor is generated at compile time. In an embodiment implemented in the C programming language, a routine or a macro may call the standard functions offsetof ( ) and sizeof ( ) for each may member of the data structure to be serialized. These standard functions generate the “offset” and “size” components of the data structure descriptor, respectively.

Once the data structure descriptor has been determined, the system can select the serialization process to be used, according to the contents of the data structure (step 204). In an exemplary embodiment, the format of the serial stream itself is standardized, so that regardless of the underlying memory layout, processor architecture, or compiling details, the serial stream that results from element 204 has a standard format. In such an embodiment, serialization routine code is controlled by the contents of the data structure so that the serialization code generates the appropriate standardized stream from the input data structure. For example, the serialization code may include a conditional statement that switches according to a byte-order flag, reversing the byte order in the serialization process where the byte-order flag is one, and not reversing the byte order where the byte-order flag is zero. As another example, the serialization code may include a conditional statement that calls a two-byte memory-read function when the “size” component of the data structure descriptor corresponding to the current member being read is 2, and a four-byte memory-read function when that “size” component is 4.

After using the data structure descriptor to select an appropriate serialization routine, the next step is serializing the data (step 206), which is carried out by packing all the members of the data structure into the serialized stream using the serialization process selected according to the parameters in the data structure descriptor. Finally, in some embodiments, the serial stream may be passed to a transmitter for transmission (step 208).

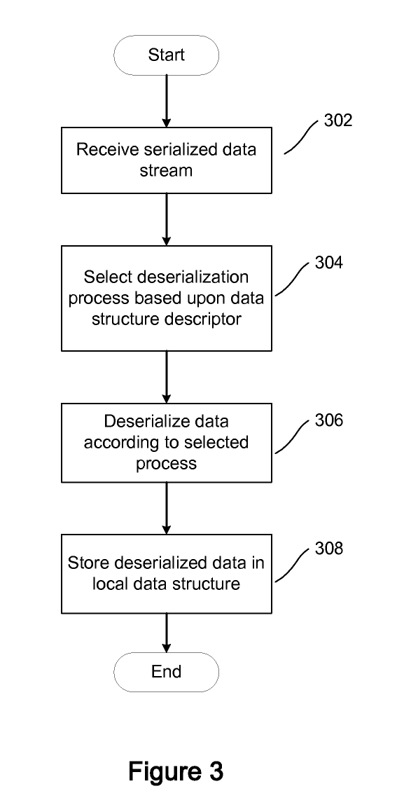

FIG. 3 illustrates an exemplary embodiment of a process for receiving and deserializing a serialized data stream generated and transmitted by a process similar to that described above in connection with FIG. 2. As with the serialization process described above, deserialization can be performed at either the host processor or the device end, depending upon which end is receiving data at a particular moment.

In the exemplary embodiment illustrated in FIG. 3, the receiving end receives the serial data stream transmitted by the transmitting end (element 302). A data structure descriptor may be passed to the deserialization routine, where it is used to select an appropriate deserialization procedure (step 304), similarly to the manner described above with respect to data serialization. As with the serialization process described above in connection with FIG. 2, the data structure descriptor may be generated at compile time.

Thus, using the information in the data structure descriptor to select the correct deserialization process, the deserialization routine can process the incoming serial stream for storage in a locally implemented data structure. The deserialization routine parses the data stream, converting the serialized data into the formats specified by the data structure descriptor and storing them in the allocated memory (steps 306 and 308).

Thus, in the process described above, the serialization program converts the data stored in the data structure to the same serial format regardless of the underlying memory layout of the data structure, which may depend upon processor-specific and/or compiler-specific parameters. Similarly, the deserialization code correctly parses the incoming stream and stores the data in a local data structure.

An advantage of these methods is that the serialization and deserialization routines need not be rewritten for implementation on host processors or devices that employ different data structures, different offsets, different endian-ness, etc. Instead of hard-coding theses processor- or device-specific aspects into the serialization and deserialization routines, serialization and deserialization processes can be included in the code that correctly account for a variety of combinations of data lengths, offsets, and endian-ness; the appropriate process is selected according to the specifics of the data structure descriptor.

As noted above, the memory layout descriptor set forth above may be used by both the device driver and the device, depending upon which end is sending and which is receiving.

### EXAMPLES

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art. What follows is some exemplary code that may be employed to implement an exemplary embodiment of the described techniques. The example illustrates one way that the described techniques may be implemented for use in a wireless transmission network.

/*
* This module is a reference implementation of “Portable object
* serialization method for embedded system”.
*
* Tested with GCC on Windows(x86), Linux(x86) and eCos(ARM9).
*
*/
#include <stdio.h>
#include <string.h>
#include <stddef.h>
#include <netinet/in.h> /* ntohl, htonl and etc */

The #include commands above load the standard header files commonly used in applications written in C, along with netinet/in.h, which defines objects specific to the wireless networking application.

/*
* Main data structure define the host object memory layout
*/
struct layout_t {

| | |
|---|---|
| int offset; | |
| int size; | |
| int convert_endian; /* | whether or not need to converting |
| | between host and network order */ |

};

The data structure layout_t defined in the above code is a three-element vector; one element describing a memory offset, the second describing and object size, and the third being a flag or other descriptor indicating whether the byte order of the data requires conversion. Each instantiation of the data structure layout_t describes the memory layout of a single member of the data structure: its offset, its size, and its endianness.

```
/*
* Main macros to generate memory layout descriptor semi-
automatically
*/
#define layoutof(type, member) \
    {offsetof(type, member), sizeof(((type *)0)->member), 1}
#define layout_no_endian(type, member) \
    {offsetof(type, member), sizeof(((type *)0)->member), 0}
#define layout_with_offset(offset, type, member) \
    {(offsetof(type, member) + offset), sizeof(((type *)0)-
>member), 1}
#define layout_with_offset_no_endian(offset, type, member) \
    {(offsetof(type, member) + offset), sizeof(((type *)0)-
>member), 0}
#define layoutof_end {−1, −1, −1}
```

Each of the definitions provided above defines a macro for creating the memory layout descriptor of a particular member “member” of a data structure “type” (except the descriptor layoutof_end, which indicates the end of the layout descriptor information). The different definitions presented above are available for exemplary implementations having different requirements of information that needs to be included in the data structure descriptor. For example, the definition layoutof (type, member) generates a three-vector whose elements are (1) the offset of the member “member” of data structure “type”; (2) the size of the member “member” of data structure “type”; and (3) a flag indicating that byte order conversion is required. The definition layout_with_offset (type, member) may be used where there is a need to additionally offset the memory layout; it generates the same three-vector, except that an offset “offset” is added to the offset of the member of the data structure. The definitions layout_no_endian and layout_with_offset_no_endian generate the same corresponding three-vectors as layoutof and layout_with_offset, respectively, except without setting the byte-conversion flag.

```
/* fast unaligned memcpy */
#define memcpy_2(to, from) \
{ \
    u_int8_t * to = (u_int8_t *)(to); \
    u_int8_t * from = (u_int8_t *)(from); \
    * to++ = * from++; \
    * to = * from; \
}
#define memcpy_4(to, from) \
{ \
    u_int8_t * to = (u_int8_t *)(to); \
    u_int8_t * from = (u_int8_t *)(from); \
    * to++ = * from++; \
    * to++ = * from++; \
    * to++ = * from++; \
    * to = * from; \
}
```

The above definitions read data from memory and are used in the serialize function defined below. memcpy_{—}2 is used to read two-byte elements from memory, while memcpy_{—}4 is used for four-byte elements.

```
int serialize(const void *object, char *stream, const struct
layout_t layouts[ ])
{
    int i;
    char *start = stream;
    for (i = 0; layouts[i].size > 0; i++)
    {
        if (layouts[i].size == 1)
        {
            *stream = *(char *)(object + layouts[i].offset);
        }
        else if ((layouts[i].size == 2) &&
(layouts[i].convert_endian))
        {
            u_int16_t tmp = htons(*(u_int16_t *)(object +
layouts[i].offset));
            memcpy_2(stream, &tmp);
        }
        else if ((layouts[i].size == 4) &&
(layouts[i].convert_endian))
        {
            u_int32_t tmp = htonl(*(u_int32_t *)(object +
layouts[i].offset));
            memcpy_4(stream, &tmp);
        }
        else
        {
            memcpy(stream, (const char *)object +
layouts[i].offset, layouts[i].size);
        }
        stream += layouts[i].size;
    }
    /* return length being written */
    return (stream - start);
}
```

The serialize function defined above reads data from the data structure and writes it to the serial stream. It uses information about the memory layout of the data structure (passed to it in the layouts [ ] variable) to ensure that the data structure is serialized correctly. For example, it accounts for the size of the members of the data structure as well as the byte order by selecting whether to call htons, htonl, memcpy2, memcpy4, etc. based upon the content of the data structure descriptor. This example illustrates a feature of the disclosed technique; because the serialization routine takes the data structure descriptor (information about the memory layout of the data structure, which in some embodiments is generated automatically at compile time) as input, the serialization routine itself is independent of the underlying memory layout, including any memory layout features that are processor-dependent, and works the same way regardless of the data structure being serialized. Therefore there is no need to rewrite the serialization code when the underlying data structures are changed for whatever reason, or when any platform-specific parameters change.

```
int deserialize (void *object, const char *stream, const struct
layout_t layouts[ ])
{
    int i;
    const char *start = stream;
    for (i = 0; layouts[i].size > 0; i++)
    {
        if (layouts[i].size == 1)
        {
            *(char *)(object + layouts[i].offset) = *stream;
        }
        if ((layouts[i].size == 2) &&
(layouts[i].convert_endian))
        {
            u_int16_t tmp;
            memcpy_2(&tmp, stream);
            *(u_int16_t *)(object + layouts[i].offset) =
ntohs(tmp);
        }
        else if ((layouts[i].size == 4) &&
(layouts[i].convert_endian))
        {
            u_int32_t tmp;
            memcpy_4(&tmp, stream);
            *(u_int32_t *)(object + layouts[i].offset) =
ntohl(tmp);
        }
        else
        {
            memcpy((char *)object + layouts[i].offset, stream,
layouts[i].size);
        }
        stream += layouts[i].size;
    }
    /* return length being read */
    return (stream - start);
}
```

The deserialize function defined above reads data from the serial stream and deserializes it into an appropriate data structure. As with the serialize function, the deserialize function takes information about the memory layout of the data structure (that, in certain embodiments, has been automatically generated at compile time) as input and uses it to ensure that the serial stream is parsed correctly and that the data structure is populated correctly; for example, it accounts for the size of the members of the data structure as well as the byte order. As with the serialize routine, because the deserialize function takes as input information about the memory layout of the data structure, the deserialization routine itself is independent of the underlying memory layout, and works the same way regardless of the data structure being populated. Therefore there is no need to rewrite the deserialization code when the underlying data structures are changed for whatever reason, or when any platform-specific parameters change.

Below, an example is presented in which the data structure to be serialized and transmitted is a tclas structure, which is the Wireless LAN traffic classification for Internet Protocol version 4 (IPv4), as defined in the IEEE 802.11e D13.0 standard. This structure is a list of integers of various lengths, representing the version of IP in use, the IP addresses of the host and the device, the identifiers of the host port and the device port in communication, the differentiated services code point value (DCSP), and a protocol identifier.

/*
* As an example, we use Wireless LAN traffic classification for
* IPv4 defined in * IEEE 802.11e D13.0
*/
/* This is the typical host side tclas definition */
typedef struct wireless_lan_ipv4_tclas {

u_int8_t version;
u_int32_t src_ip;
u_int32_t dst_ip;
u_int16_t src_port;
u_int16_t dst_port;
u_int8_t dscp;
u_int8_t protocol;

} ipv4_tclas_t;
/* Semi-auto generated memory layout descriptor for the
ipv4_tclas_t */
struct layout_t ipv4_tclas_layout[ ] = {

layoutof(ipv4_tclas_t, version),
layoutof(ipv4_tclas_t, src_ip),
layoutof(ipv4_tclas_t, dst_ip),
layoutof(ipv4_tclas_t, src_port),
layoutof(ipv4_tclas_t, dst_port),
layoutof(ipv4_tclas_t, dscp),
layoutof(ipv4_tclas_t, protocol),
layoutof_end

};

The above code includes a definition of the tclas data structure, and also makes use of the layout_t structure describing the memory layout of each element in the data structure, as discussed above in connection with the layout_t definition.

void mem_dump(void *p, int len)
{

int i;
unsigned char *c = (unsigned char *) p;
for (i = 0; i < len; i++)
{
printf(“%2.2x ”, *c++);
}
printf(“\n”);

}
int main( )
{

| /* | |
|---|---|
| * In this example, we defined a tclas, serialize it and | |
| * deserialize it | |
| */ | |
| /* define a tclas with: | |
| * version | = 4 |
| * src_ip | = 1.1.1.2 |
| * dst_ip | = 2.2.2.3 |
| * src_port | = 4096 |
| * dst_port | = 4097 |
| * dscp | = 0 |
| * protocol | = 6 (TCP) |
| */ | |

ipv4_tclas_t from = {4, 0x01010102, 0x02020203, 0x1000,

0x1001, 0, 6};

ipv4_tclas_t to;
char stream[sizeof(ipv4_tclas_t)];
int stream_len;
stream_len = serialize(&from, stream, ipv4_tclas_layout);
deserialize(&to, stream, ipv4_tclas_layout);
printf(“object on host processor:\n”);
mem_dump(&from, sizeof(from));
printf(“\n”);
printf(“serialized object:\n”);
mem_dump(&stream, stream_len);
printf(“\n”);
printf(“tclas on target processor:\n”);
mem_dump(&to, sizeof(to));
printf(“\n”);
return 0;

}

The main ( ) routine shown above calls the serialize routine to serialize the ipv4 data structure, and then calls the deserialize routine to deserialize it. It includes calls to the diagnostic mem_dump function so that the operator may verify that the data were serialized and deserialized correctly.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of serializing data for transmission wherein the data is stored in a data structure, the method comprising:
generating a data structure descriptor, the data structure descriptor representing information about a memory layout of the data structure; and
serializing the data stored in the data structure based upon the data structure descriptor.

2. The method of claim 1, wherein the data structure includes at least one member, and wherein generating a data structure descriptor includes generating a layout array corresponding to each of the at least one members of the data structure.

3. The method of claim 2, wherein the layout array corresponding to each member of the data structure includes a memory offset and a size of the member of the data structure.

4. A method of processing serially received data for storage in a data structure, the method comprising:
receiving a serial data stream;
allocating memory for storing the data based upon a data structure descriptor; and
deserializing the data stream based upon the data structure descriptor.

5. The method of claim 4, wherein the data structure includes at least one member, and wherein the data structure descriptor includes a layout array corresponding to each member of the data structure.

6. The method of claim 5, wherein the layout array corresponding to each member of the data structure includes a memory offset and a size of the member of the data structure.

7. A system for serializing data for transmission wherein the data is stored in a data structure, the system comprising a processor configured to:
generate a data structure descriptor, the data structure descriptor representing information about a memory layout of the data structure; and
serialize the data stored in the data structure based upon the data structure descriptor.

8. The system of claim 7, wherein the data structure includes at least one member, and wherein the data structure descriptor includes a layout array corresponding to each member of the data structure.

9. The system of claim 8, wherein the layout array corresponding to each member of the data structure includes a memory offset and a size of the member of the data structure.

10. A system for processing serially received data for storage in a data structure, the system comprising a processor configured to:
receive a serial data stream;
allocate memory for the data structure based upon a data structure descriptor; and
deserialize the data stream based upon the data structure descriptor.

11. The system of claim 10, wherein the data structure includes at least one member, and wherein the data structure descriptor includes a layout array corresponding to each member of the data structure.

12. The system of claim 11, wherein the layout array corresponding to each member of the data structure includes a memory offset and a size of the member of the data structure.

13. A machine-readable medium carrying instructions for carrying out a method of serializing data for transmission wherein the data is stored in a data structure, the method comprising:
generating a data structure descriptor, the data structure descriptor representing information about a memory layout of the data structure; and
serializing the data stored in the data structure based upon the data structure descriptor.

14. The machine-readable medium of claim 13, wherein the data structure includes at least one member, and wherein the act of generating a data structure descriptor includes generating a layout array corresponding to each of the at least one members of the data structure.

15. The machine-readable medium of claim 14, wherein the layout array corresponding to each member of the data structure includes a memory offset and a size of the member of the data structure.

16. A machine-readable medium carrying instructions for carrying out a method of processing serially received data for storage in a data structure, the method comprising:
receiving a serial data stream;
allocating memory for storing the data based upon a data structure descriptor; and
deserializing the data stream based upon the data structure descriptor.

17. The machine-readable medium of claim 16, wherein the data structure includes at least one member, and wherein the data structure descriptor includes a layout array corresponding to each member of the data structure.

18. The machine-readable medium of claim 17, wherein the layout array corresponding to each member of the data structure includes a memory offset and a size of the member of the data structure.
